(19) United States
(12) Patent Application Publication
(10) Pub. No.: US 2022/0215699 A1
(43) Pub. Date: Jul. 7, 2022

(54) METHOD AND DEVICE FOR CONTROLLING AN AUTOMATICALLY DRIVING VEHICLE

(71) Applicant: Daimler AG, Stuttgart (DE)

(72) Inventor: Christian MAIHOEFER, Iggingen (DE)

(21) Appl. No.: 17/603,868

(22) PCT Filed: Mar. 20, 2020
(86) PCT No.: PCT/EP2020/057723

§ 371 Date: Oct. 14, 2021

(30) Foreign Application Priority Data
Apr. 16, 2019 (DE) 10 2019 002 789.2

(51) Int. Cl. G07C 5/04; G07C 5/00; G05D 1/00; B60W 60/00

(52) U.S. Cl. CPC G07C 5/04; G07C 5/008; G05D 1/0022; B60W 2420/54; B60W 2420/52; B60W 2420/42; B60W 2510/06; B60W 60/001

(57) ABSTRACT

A method for controlling an automatically driving vehicle by a vehicle control center includes transmitting a sensor signal recorded on a part of the vehicle to the vehicle control center, where the sensor signal has a time stamp, and checking the time stamp in the vehicle control center upon receipt of the sensor signal. When a predetermined first age of the time stamp of the sensor signal is exceeded the sensor signal is displayed in a marked manner to a teleoperator of the vehicle control center for identifying a signal delay and when the time stamp exceeds a predetermined second age a display of the sensor signal is suppressed.

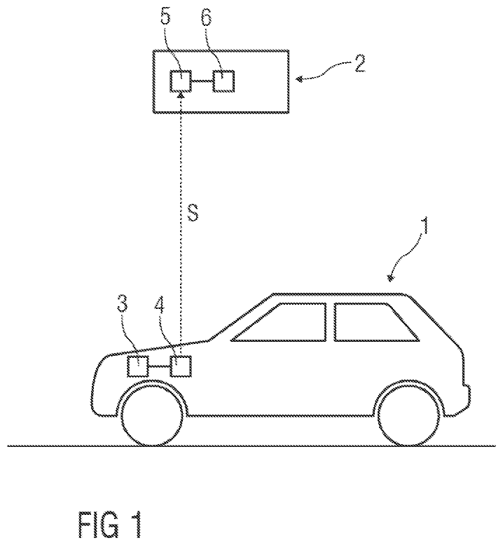

### BACKGROUND AND SUMMARY OF THE INVENTION

The invention relates to a method for controlling an automatically driving vehicle by means of a vehicle control center, wherein sensor signals detected on the part of the vehicle are transmitted to the vehicle control center, and the vehicle is controlled by means of the vehicle control center depending on the sensor signals. Furthermore, the invention relates to a device for carrying out the method.

A method for operating a motor vehicle and a motor vehicle are known from DE 10 2014 015 493 A1. The motor vehicle comprises at least one sensor device and an assistance device, wherein, in a first operating mode of the assistance device, surroundings data describing the surroundings of the motor vehicle are recorded by the sensor device. The assistance device automatically guides the motor vehicle depending on the surroundings data by controlling at least one actuator of the motor vehicle without intervention by a driver. Here, the assistance device switches into a second operating mode upon fulfilling a switching condition evaluating the surroundings data, wherein, in this, at least one part of the surroundings data is wirelessly transmitted to a stationary remote control device and is visualized there for an operating person external to the vehicle. Depending on operating inputs of the operating person on the remote control device, driving intervention data, which describe driving interventions in the driving operation of the motor vehicle, are ascertained and wirelessly transmitted to the motor vehicle, according to which the assistance device guides the motor vehicle by controlling the actuator according to the vehicle intervention data.

The object of the invention is to specify an improved method over the prior art for controlling an automatically driving vehicle by means of a vehicle control center and a device for carrying out the method.

According to the invention, a method for controlling an automatically driving vehicle by means of a vehicle control center, wherein sensor signals recorded on the part of the vehicle are transmitted to the vehicle control center, and the vehicle is controlled depending on the sensor signals by means of the vehicle control center, provides that the respective sensor signal is provided on the side of the vehicle with a time stamp, wherein the time stamp is checked on receipt of the respective sensor signal in the vehicle control center and, upon exceeding a predetermined first age of the time stamp of the respective sensor signal, this is displayed to a teleoperator of the vehicle control center for identifying a signal delay, and displaying the sensor signal, the time stamp of which exceeding a predetermined second age, is suppressed.

By using the method, the currency of the sensor signals transmitted to the vehicle control center on the part of the vehicle is ascertained and, when the currency is not present, the control of the vehicle is not taken into consideration.

In particular, the method presents a solution with which the vehicle, which can control a destination without a driver, can be controlled by the vehicle control center in such a way that information on the part of the vehicle required for the control are up-to-date and its age and thus its currency can be established and displayed in the vehicle control center.

In a design of the method, the sensor signal is marked by means of displaying an absolute delay value and/or by means of displaying a color coding, such that the age of the sensor signal is obvious to the teleoperator and can thus be taken into consideration when controlling the vehicle. In particular, the teleoperator can ascertain by means of the time stamp of the corresponding sensor signal, i.e., by means of the displayed delay value and/or the color code, whether the teleoperator manually intervenes with the control of the vehicle, in order to transfer it into a safer state, for example, in particular a standstill in a safer region.

In a further embodiment, the marking of the sensor signal is varied depending on the age of the sensor signal, wherein when it is ascertained that a signal delay has been exceeded, the sensor signal is displayed in a first color, for example in yellow, and when it is ascertained that a further signal delay has been exceeded, the sensor signal is displayed in a second color, for example in red, such that the teleoperator is made aware of the age of the sensor signal.

A development of the method provides that sending at least one sensor signal is requested, explicitly requested, by means of the vehicle control center, and an elapsed time duration before conveying the at least one requested sensor signal is recorded. Here, the request time is counted, wherein this development depicts a relatively safe possibility for ascertaining the currency of sensor signals sent on the part of the vehicle. Here, more sensor signals may be discarded than necessary, wherein the display of a potentially or actually outdated sensor signal can nevertheless be extensively precluded.

In the event of an exceeded second age of the time stamp of the sensor signal, if this is still displayed, a command sent to the vehicle by the teleoperator is rejected or a confirmation is requested. An action to be carried out by means of the command is thus rejected or it is necessary for the vehicle control center to confirm the conveyance of the command to the vehicle. Thus, the safety in relation to carrying out the method can be increased.

In a possible development, which again increases the safety, carrying out the command is rejected by the vehicle and not by the vehicle control center. To do so, a signal delay is not only determined in the vehicle control center but also in the vehicle. Thus, it is possible for the vehicle to be able to determine an age of the sensor signal upon receipt by means of the vehicle control center and to be able to reject subsequent commands, if the age of the sensor signal has previously or simultaneously exceeded a certain time threshold.

In particular, as the sensor signal, a video signal, an audio signal, a light and/or driving direction indicator signal, an ignition signal, an engine signal, a signal of a radar-based, lidar-based and/or ultrasonic-based sensor and/or a signal of a laser scanner are or is transmitted to the vehicle control center.

Moreover, the invention relates to a device for controlling an automatically driving vehicle by means of a vehicle control center, wherein the vehicle transmits recorded sensor signals to the vehicle control center by means of a control unit, and the vehicle control center controls the vehicle depending on the sensor signals. According to the invention, it is provided that the control unit provides the sensor signal with a time stamp, wherein a further control unit of the vehicle control center is formed for checking the time stamp upon receipt of the respective sensor signal and, if a predetermined first age of the time stamp of the respective sensor signal is exceeded, the further control unit marks it, wherein a display unit coupled in a data-technical manner to the further control unit displays the sensor signal in a marked manner to a teleoperator for identifying a signal delay, and the further control unit suppresses the display of a sensor signal whose time stamp exceeds a predetermined second age.

Carrying out the method described above is possible by means of the device, such that a comparably safe control of the vehicle by means of the vehicle control center can be implemented, such that the vehicle can be moved into a safe region or can once again take up an automatic driving operation.

Exemplary embodiments of the invention are explained in more detail below by means of a drawing.

### BRIEF DESCRIPTION OF THE DRAWING

The FIGURE shows schematically a vehicle which is connected to a vehicle control center in a data-technical manner.

### DETAILED DESCRIPTION OF THE DRAWING

In the single FIGURE, a vehicle 1 and a vehicle control center 2 are depicted, wherein the vehicle 1 is connected in a data-technical manner to the vehicle control center 2.

The vehicle 1 can be controlled by means of the vehicle control center 2, such that a driving operation of the vehicle 1 can be carried out automatically and without a driver depending on sensor signals S recorded on the part of the vehicle.

Typically, an autonomy of the vehicle 1 is primarily limited when safe driving operation of the vehicle 1, i.e., safe progressive movement, is no longer possible due to recorded sensor signals S of a vehicle sensor system 3 and also by means of a highly accurate digital map and a controller integrated in the vehicle.

Thus, it can be, for example, that light signals of a light signal system cannot be detected by means of at least one sensor on the part of the vehicle, for example a camera, because of a snowdrift. It can also be that a police officer regulates the traffic due to an accident and/or that a relatively new building site does not have a completely functioning protection and light signaling system.

To do so, it is necessary for the vehicle sensor system 3 and the vehicle control center 2 to recognize such a state by means of recorded sensor signals S and for the vehicle 2 to be shifted into a safe state, in particular operating state, which is achieved, for example, by the vehicle 1 stopping, parking on a hard shoulder of a road, inter alia.

In order to again shift the vehicle 1 out of the safe operating state into the automatic driving operation, or in order to move the vehicle 1 away at least out of a certain region, in which the vehicle 1 interferes, for example, a method described below is provided.

It is known that sensor signals S recorded on the part of the vehicle are evaluated by means of the vehicle control center 2 and the vehicle 1 is manually moved out of the region by means of commands of a teleoperator of the vehicle control center 2 or is shifted into the automatic driving operation.

For this, the method provides that a currency, i.e., an age, of the sensor signals S sent on the part of the vehicle to the vehicle control center 2 is ascertained, in order to correspondingly determined a further process in relation to the vehicle 1 in the safe operating state.

As sensor signals S on the part of the vehicle, by way of example, video signals of an image recording unit of the vehicle 1 are transmitted to the vehicle control center 2, wherein what a human vehicle user would see, in particular, is reproduced by means of the video signals. Alternatively or additionally, lateral surroundings images directed and recorded towards the back of the vehicle 1 and/or other recorded surroundings images of the vehicle 1 are transmitted as sensor signals S on the part of the vehicle to the vehicle control center 2.

Aerial view camera signals of the vehicle 1 and/or a camera signal from a bird's eye perspective and/or image signals of a night vision camera can also be transmitted as the sensor signal S to the vehicle control signal 2.

In turn, alternatively or additionally, audio signals, which emit a siren, light signals, driving direction indicator signals, state signals of an ignition and/or engine signals are transmitted as the sensor signals S to the vehicle control center 2.

As explained above, the vehicle 1 has the vehicle sensor system 3, which comprises a number of detection units arranged in and/or on the vehicle 1, such that radar-based, lidar-based and/or ultrasound-based signals, for example, and/or a signal of a laser scanner can be transmitted as sensor signals S to the vehicle control center 2.

In an embodiment of the method, there is a common time base between the vehicle 1 and the vehicle control center 2, e.g., as a result of sufficiently exact hours, which are synchronized, for example, on an atomic clock via a radio connection, in particular via WLAN.

The vehicle 1, i.e., a control unit 4 of the vehicle 1 connected in a data-technical manner to the vehicle sensor system 2, provides each sensor signal S to be sent with a time stamp.

When transmitting the respective sensor signals S provided with a time stamp, various signal delays can occur until the sensor signal S is received by the vehicle control center 2 and is displayed there in a corresponding application program, in particular for the teleoperator.

For example, an existing radio connection between the vehicle 1 and the vehicle control center 2 can be responsible for the signal delay when transmitting the sensor signals S. It can also be that the signal delays occur due to the internet, the vehicle control center 2 and/or an IT infrastructure in general.

The respective sensor signal S provided with a time stamp is checked in relation to the time stamp upon receipt by means of a further control unit 5 of the vehicle control center 2 and an age, i.e., a transmission time and thus a signal delay, of the sensor signal S is ascertained.

If the transmission time as the signal delay of a sensor signal S exceeds a first age stored in the further control unit 5, then the sensor signal S is optically output on a display unit 6 connected to the further control unit 5 for identifying in a marked manner. By means of the identification, the respective teleoperator of the vehicle control center 2 is made aware of the signal delay and thus of the age of the received sensor signal S.

If, when analyzing the time stamp of a sensor signal S transmitted on the part of the vehicle to the vehicle control center 2, a second age stored in the further control unit 5 is exceeded, then displaying this sensor signal S on the display unit 6 is suppressed by means of the further control unit 5. This sensor signal S is thus not displayed to the teleoperator.

For example, the identification of the transmitted sensor signal S whose time stamp exceeds the first age in relation to the signal delay is carried out by means of displaying an absolute delay value and/or by means of a color coding and/or another suitable coding.

For example, as the sensor signal S, a video signal is transmitted from the vehicle 1 in the safe operating state to the vehicle control center 2, which is provided with a time stamp of 12 h35 min12 sec150 msec. Upon receipt of the sensor signal S in the further control unit 5, a receipt time stamp is 12 h35 min15 sec950 msec, such that the signal delay is 800 msec. Such a delay value is graded as comparatively high, such that the sensor signal S output on the display unit 6 is displayed in the form of the video signal outlined in yellow. If the delay value is 1 sec, for example, then the sensor signal S can be displayed outlined in red, in order to make the teleoperator aware of the age of the received sensor signal S.

If the delay value is 1.5 sec, for example, the optical output of the sensor signal S would be switched off by means of the display unit 6. The display of this sensor signal S whose signal delay exceeds the predetermined second age is thus suppressed.

For example, the color coding is carried out to the effect that, with a signal delay approximating the second age, the sensor signal S is marked with a different color than when the signal delay is not as high.

In a further embodiment, the further control unit 5 of the vehicle control center 2 explicitly requests a sensor signal S of the vehicle 1. The further control unit 5 then waits for the receipt of the requested sensor signal S and here records a time duration from the point in time of the request until the receipt of the sensor signal S. Here, the request time is also taken into consideration, i.e., also counted, yet this second embodiment can be seen as a relatively safe determination for signal delays, since more sensor signals S are discarded due to the inclusion of the request time than would be necessary, yet sensor signals S, which exceed the predetermined second age, i.e., are potentially or actually dated, are not displayed.

Furthermore, it can be provided that sensor signals S received by the further control unit 5 are always displayed by means of the display unit 6, even if the signal delay exceeds the predetermined second age. If the vehicle control center 2 or a teleoperator intends to transmit a command for implementing an action to the vehicle 1, this is not transmitted when a corresponding signal delay is present. Alternatively, the command for implementing is transmitted to the vehicle 1 when the vehicle control center 2 again confirms this transmission.

A further embodiment of the method by means of which the implementation thereof can be increased provides that it is not the vehicle control center 2 that rejects the transmission and implementation of the command, but rather the vehicle 1, i.e., its control unit 4, rejects the implementation of the command.

For this, it is necessary for the signal delay to not only be ascertained in the vehicle control center 2 but also in the vehicle 1. For example, the determination takes place by the receipt of the sensor signals S, which are transmitted from the vehicle 1 to the vehicle control center 2, being confirmed again on the vehicle 1. Thus, it is possible that the vehicle 1 can also determine the age of the sensor signals S, i.e., the time duration for transmission. Based on this, the vehicle 1 can reject the implementation of the command transmitted by the vehicle control center 2 if the age of the sensor signals S has already or simultaneously exceeded the predetermined second age as the threshold value.

1.-8. (canceled)

9. A method for controlling an automatically driving vehicle by a vehicle control center, comprising the steps of:
transmitting a sensor signal recorded on a part of the vehicle to the vehicle control center, wherein the sensor signal has a time stamp; and
checking the time stamp in the vehicle control center upon receipt of the sensor signal;
wherein when a predetermined first age of the time stamp of the sensor signal is exceeded the sensor signal is displayed in a marked manner to a teleoperator of the vehicle control center for identifying a signal delay; and
wherein when the time stamp exceeds a predetermined second age a display of the sensor signal is suppressed.

10. The method according to claim 9, wherein the sensor signal is displayed in a marked manner by displaying an absolute delay value and/or by displaying a color coding.

11. The method according to claim 9, wherein the marked manner is varied depending on an age of the sensor signal.

12. The method according to claim 9, further comprising the steps of requesting the transmitting of the sensor signal by the vehicle control center and recording a time duration that has elapsed from the requesting to the transmitting.

13. The method according to claim 9, wherein when the time stamp exceeds the predetermined second age and the display of the sensor signal is not suppressed, a command sent by the vehicle control center to the vehicle is either rejected or a confirmation is requested.

14. The method according to claim 13, wherein an implementation of the command is rejected by the vehicle.

15. The method according to claim 9, wherein the sensor signal is a video signal or an audio signal or a driving direction indicator signal or an ignition signal or an engine signal or a signal of a radar-based sensor or a signal of a lidar-based sensor or a signal of an ultrasonic-based sensor or a signal of a laser scanner.

16. An apparatus for controlling an automatically driving vehicle, comprising:
a vehicle control center;
a first control unit of the vehicle, wherein the vehicle transmits a sensor signal recorded on a part of the vehicle to the vehicle control center via the first control unit and wherein the first control unit provides the sensor signal with a time stamp;
a second control unit of the vehicle control center, wherein the second control unit checks the time stamp upon receipt of the sensor signal at the vehicle control center; and
a display unit coupled to the second control unit;
wherein when a predetermined first age of the time stamp of the sensor signal is exceeded, the second control unit marks the sensor signal and the display unit displays the sensor signal in a marked manner to a teleoperator of the vehicle control center for identifying a signal delay;
wherein when the time stamp exceeds a predetermined second age a display of the sensor signal is suppressed by the second control unit.
